(19) United States
(12) Patent Application Publication
(10) Pub. No.: US 2003/0072939 A1
(43) Pub. Date: Apr. 17, 2003

(54) Elastic tape with transverse stiffening

(76) Inventor: Hans Sachse, Nuernberg (DE)

Correspondence Address: Herbert B. Keil, Keil & Weinkauf, 1101 Connecticut Ave., N.W., Wahington, DC, 20036, US

(21) Appl. No.: 09/976,073

(22) Filed: Oct. 15, 2001

(51) Int. Cl. B32B 7/12; B32B 15/04; D02G 3/00

(52) U.S. Cl. 428/343; 428/375; 428/354; 428/345

(57) ABSTRACT

Transverse stiffening of the elastic tape is provided by means of the application of beads of a homogenous material, preferably an adhesive. Applied in liquid form, this material bonds with the surface of the elastic tape, or penetrates it, and in this manner adheres firmly. Following a curing process, the homogenous mass has the required properties and provides the elastic tape with the desired transverse stiffening.

### BACKGROUND OF THE INVENTION

Elastic tapes are often employed in the field of medicine for immobilizing and stiffening. In accordance with German Patent DE 197 24 441 C2 (equivalent to U.S. Pat. No. 6,015,379, incorporated herein by reference), for example, a stiffening tape is also used for improving cohabitation capability. However, the stiffening possibilities described therein entail considerable costs in production.

### BRIEF SUMMARY OF THE INVENTION

The present invention makes use of the further development of adhesives, which has taken place in the meantime, for a cost-effective partial stiffening of elastic tapes. The goal here is always not to interfere with the longitudinal elastic properties of the tape for the intended function. A material is to be selected for this object, which can be applied in liquid form in beads on the elastic tape, makes a solid connection with the tape in this state and is cured thereafter to obtain its required stability.

### BRIEF DESCRIPTION OF THE DRAWINGS

FIG. 1 shows a longitudinal section through a portion of the elastic tape. The embodiment of the invention in accordance with FIG. 1 shows an elastic tape comprised of a denser structure 2 and a more open structure 1. The stiffening strip 3 is seated on the open surface 1, and its extensions 4 have penetrated the loose portion 1 of the elastic tape and solidly adhere to it.

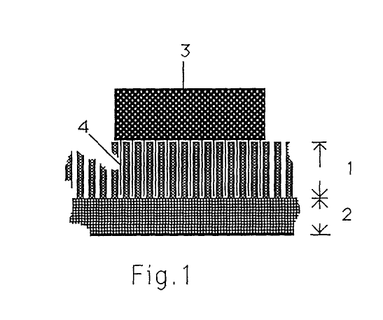

### DETAILED DESCRIPTION OF THE INVENTION

In accordance with claims 1 and 2, a homogenous mass, preferably an adhesive, is applied in beads transversely to the longitudinal direction of the tape which, when applied, makes a solid connection with the tape, and then obtains its required solidity by means of a curing process. In accordance with claims 2 to 6, this can be an adhesive which cures in a period of time sufficient for production and which, in accordance with claim 7, is well tolerated when in contact with the human skin. Further advantages and characteristics of the invention can be taken from the further dependent claims, to whose contents specific reference is made here, as well as from the drawings and the associated description given above.

A preferred adhesive is Loctite 3321, a UV acrylate adhesive, which is applied in liquid form and contains optical initiators. If this adhesive is radiated under blue light, or exposed to UV radiation, the activation of the optical initiators starts the curing process.

The partially-stiffened elastic tape may also be used for orthopedic or other suitable purposes, for example, in stabilizing a broken finger, where the stabilization should be around and also in the longitudinal axis, similar to the stabilization described in DE 197 24 441 C2.

1. A tape, elastic in the longitudinal direction and having a transverse stiffening, which essentially does not hamper elasticity, characterized in that the transverse stiffening 3 consists of a homogenous material, which forms a solid connection with the surface 1 of the elastic tape and has been applied in the form of beads, so that the elastic property of the tape is still sufficiently preserved.

2. The tape in accordance with claim 1, characterized in that the stiffening material of the stiffening strip 3 consists of an adhesive, which is applied in liquid form, in the process makes a firm connection with the elastic tape, either by adhering to the surface or by the penetration of extension 4 into a loose surface structure I of the elastic tape, and which thereafter obtains its required more solid properties by curing.

3. The tape in accordance with claim 2, characterized in that the adhesive is a so-called 2-component adhesive.

4. The tape in accordance with claim 2, characterized in that the adhesive is an adhesive which is cured by UV radiation.

5. The tape in accordance with claim 2, characterized in that the adhesive is an adhesive which is cured by means of a temperature change.

6. The tape in accordance with claim 2, characterized in that the adhesive is an adhesive which was not yet mentioned in the above claims and which, by means of its properties, cures within a period of time sufficient for production.

7. The tape in accordance with claim 2, characterized in that the adhesive is well tolerated by humans and does not cause injuries.
